(19) United States
(12) Patent Application Publication
(10) Pub. No.: US 2022/0048626 A1
(43) Pub. Date: Feb. 17, 2022

(54) EXTERNAL LOAD TRANSPORT ASSEMBLY FOR AN AERIAL VEHICLE AND USE OF THE SAME FOR THE CONSTRUCTION AND MAINTENANCE OF POWER LINES

(71) Applicant: Boost Human External Cargo Systems Inc., Vancouver (CA)

(72) Inventors: Jeff Yarnold, North Vancouver (CA); Derek Thomas, North Vancouver (CA); Colin Patrick O'Neill, Vancouver (CA); Paul William Beau Allard, North Vancouver (CA)

(73) Assignee: Boost Human External Cargo Systems Inc., Vancouver (CA)

(21) Appl. No.: 17/401,097

(22) Filed: Aug. 12, 2021

Related U.S. Application Data
(60) Provisional application No. 63/065,100, filed on Aug. 13, 2020.

(51) Int. Cl. B64D 9/00; G01K 11/12; G01N 21/81

(52) U.S. Cl. CPC B64D 9/00; G01N 2021/7759; G01N 21/81; G01K 11/12

(57) ABSTRACT

There is provided an external load transport assembly for an aerial vehicle. The assembly includes a load suspension line having a first end connectable to the aerial vehicle and a second end connectable to an external load. The assembly includes a relative humidity indicator positioned to monitor moisture content of the load suspension line. The assembly includes an at least partially transparent coating encasing the load suspension line and the relative humidity indicator.

### BACKGROUND OF THE INVENTION

### Field of the Invention

There is provided an external load transport assembly. In particular, there is provided an external load transport assembly for an aerial vehicle for use in construction and maintenance of power of lines.

### Description of the Related Art

U.S. Pat. No. 10,532,819 to Lemke discloses an apparatus and methods for supporting human external cargo from the hoist of a hoist-equipped helicopter. The apparatus has at least one personal harness for supporting a user; and at least one harness segment with a top end point attachable to the helicopter hoist through an attachable fitting and at least one bottom end point directly or indirectly attachable to the personal harness. The harness segment, and the personal harness externally support the user from the helicopter hoist and allows the user to be safely suspended from the helicopter in order for work or rescue operations to be administered by the user.

### BRIEF SUMMARY OF INVENTION

There is provided, and it is an object to provide, an improved external load transport assembly.

There is provided an external load transport assembly for an aerial vehicle. The assembly includes a load suspension line having a first end connectable to the aerial vehicle and a second end connectable to an external load. The assembly includes a relative humidity indicator positioned to monitor moisture content of the load suspension line. The assembly includes an at least partially transparent coating encasing the load suspension line and the relative humidity indicator.

There is also provided a transport assembly for an aerial vehicle. The assembly includes a load suspension line extending between and selectively coupling an external load to an undercarriage of the aerial vehicle. The assembly includes a relative humidity indicator coupled to the load suspension line. The assembly includes an at least partially transparent coating encasing the load suspension line and the relative humidity indicator.

There is further provided use of one of the above described transport assemblies for construction or maintenance of power lines.

There is additionally provided, in combination, an aerial vehicle and one of the above described transport assemblies.

There is yet also provided a load suspension line having a first end connectable to an aerial vehicle. The load suspension line has a second end connectable to an external load. The load suspension line includes synthetic rope. The load suspension line includes a relative humidity indicator positioned to monitor moisture content of the synthetic rope. The load suspension line includes an at least partially transparent coating encasing the synthetic rope and the relative humidity indicator.

There is yet further provided a load suspension line for coupling an external load to an aerial vehicle. The load suspension line is made of non-conducting material. The load suspension line includes a relative humidity indicator positioned to monitor moisture content thereof. The load suspension line includes an at least partially transparent coating encasing the relative humidity indicator.

There is also provided a method of determining whether one or more dielectric properties of a load suspension line of an external load transport assembly for an aerial vehicle have changed. The load suspension line is made of non-conducting material. The method includes coupling one or more relative humidity indicators to the synthetic rope. The method includes encasing the one or more relative humidity indicators and portions of the rope adjacent thereto in an at least partially transparent coating. The method includes testing conductivity of the load suspension line over a certain segment thereof. The method includes visually inspecting the one or more relative humidity indicators. The method includes determining that the load suspension line is a dielectric state when both i) the color of the one or more relative humidity indicators is determined to have not changed one or more predetermined color thresholds; and ii) conductivity of the load suspension line over the certain segment has not exceeded a predetermined conductivity threshold.

There is further provided a method of determining whether one or more dielectric properties of a load suspension line of an external load transport assembly for an aerial vehicle have changed. The load suspension line is made of non-conducting material. The method includes coupling one or more relative humidity indicators to the synthetic rope. The method includes encasing the one or more relative humidity indicators and portions of the rope adjacent thereto in an at least partially transparent coating. The method includes determining whether the one or more relative humidity indicators have changed color past a predetermined color threshold. If the one or more humidity indicators have changed color past the predetermined color threshold, the method further includes testing conductivity of the load suspension line between segments thereof. If the test result is below a pre-determined conductivity threshold, the method includes determining that the load suspension line is suitable for use as the dielectric said load suspension line. If the conductivity of the load suspension line exceeds the pre-determined conductivity threshold, the method includes determining that the load suspension line is not suitable for use as the dielectric said load suspension line.

### BRIEF DESCRIPTION OF DRAWINGS

The invention will be more readily understood from the following description of preferred embodiments thereof given, by way of example only, with reference to the accompanying drawings, in which:

FIG. 1 is a top, side, front perspective view of a transmission tower, a power line maintenance worker adjacent to the tower, an aerial vehicle, and an external load transport assembly according to a first aspect via which the worker is coupled to and suspended from the aerial vehicle;

FIG. 2 is a side perspective view of a connector plate of the external load transport assembly of FIG. 1 coupling a second end of a load suspension line of the external load transport assembly to a harness of the worker of FIG. 1, with the harness and load suspension line shown in fragment;

FIG. 3 is an exploded, side, top, end perspective view of the external load transport assembly of FIG. 1 shown partially assembled;

FIG. 4 is a side elevation view of the partially assembly external load transport assembly of FIG. 3;

FIG. 5 is a sectional view taken in lateral cross-section along lines 5-5 of the external load transport assembly of FIG. 3, showing the load suspension line thereof together with a mesh and a transparent coating encasing the load suspension line;

FIG. 6 is a side, top, end perspective view of the external load transport assembly of FIG. 3 more fully assembled;

FIG. 7 is an exploded, side, top, end perspective of one of a pair of coupling mechanisms of the external load transport assembly of FIG. 1, with the rest of the external load transport assembly not being shown;

FIG. 8 is an elevation perspective view of a first end portion of the external load transport assembly of FIG. 1, together with a pair of elongate lanyards coupled thereto, with the external load transport assembly being shown in fragment and the rest of the external load transport assembly not being shown;

FIG. 9 is a side, top perspective fully assembled view of the external load transport assembly of FIG. 1;

FIG. 10 is a schematic view of an algorithm for determining whether the load suspension line of the external load transport assembly of FIG. 1 is in a dielectric state; and

FIG. 11 is a top, side, front perspective view of a transmission tower, a power line maintenance worker adjacent to the tower, an aerial vehicle, and an external load transport assembly according to a second aspect and via which the worker is coupled to and suspended from the aerial vehicle.

### DESCRIPTION OF THE PREFERRED EMBODIMENTS

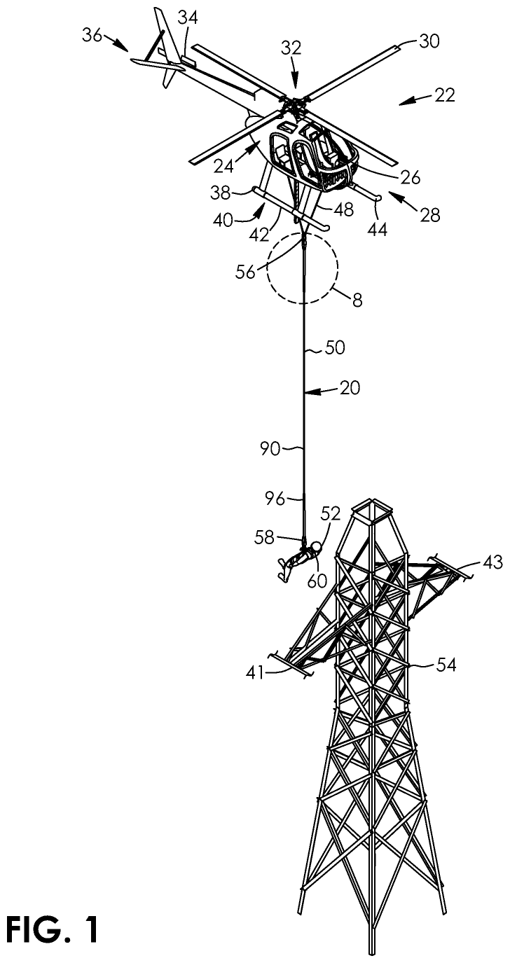

Referring to the drawings and first to FIG. 1, there is shown an external load transport assembly 20 for an aerial vehicle, in this example a helicopter 22. The helicopter includes an aircraft structure or body 24 with a cockpit 26 at a front 28 thereof. The helicopter 22 includes a main rotor 30 coupled to the top 32 thereof and a tail rotor 34 coupled to a rear 36 thereof. The helicopter includes a landing gear or undercarriage 38 coupled to the underside or belly 40 of the body 24 thereof. The undercarriage of the helicopter includes a pair of spaced-apart skids 42 and 44. Helicopters per se, including their various parts and functions, are well known to those skilled in the art and helicopter 22 will accordingly not be described in further detail.

The external load transport assembly 20 may include a belly band (not shown) which extends about the body 24 of the helicopter 22. The external load transport assembly 20 may include a quick-release system (not shown) and a pair of elongate lanyards 48 and 49. An example of the former is also described in more detail in U.S. patent application Ser. No. 10/745,131.

Still referring to FIG. 1, the external load transport assembly 20 includes a load suspension line 50. The load suspension line is a low-stretch line that extends between and selectively couples an external load, in this example a human, in this case a power line maintenance worker 52, to the undercarriage 38 and/or belly 40 of the helicopter 22. However, this is not strictly required and the external load may be a non-human external cargo in other examples. The power line maintenance worker 52 is shown suspended from the helicopter 22 and working on and adjacent to an energized structure, in this example a transmission tower 54 for the repair and maintenance thereof. The transmission tower is coupled to and supports high voltage transmission lines 41 and 43. The external load transport assembly 20 is configured to safely suspend the worker 52 from under the undercarriage 38 and/or belly 40 of the helicopter 22 via the load suspension line 50 such that the person is suspended beneath the skids 42 and 44 of the helicopter 22 in this example.

The load suspension line 50 has a first end that selectively couples to the belly band and/or belly-mounted load beam via the Y-lanyard 48. The belly band and/or belly-mounted load beam and/or belly mounted secondary cargo hook may function as secondary points of attachment and release, and the load suspension line may be released from the belly band via the integrated quick release device (not shown). The load suspension line 50 has a second end 58 spaced-apart from the first end.

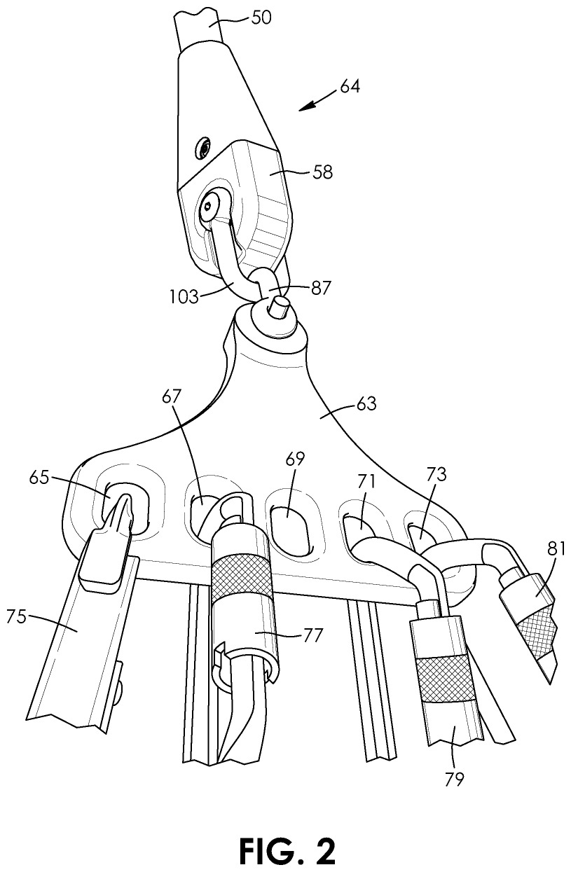

The external load transport assembly 20 includes a harness 60 for the worker 52 to wear. As seen in FIG. 2, the assembly includes a connecting member, in this example a connector plate 63 having a plurality of first connections points, in this example comprising apertures 65, 67, 69, 71 and 73. The harness 60 selectively couples to the connector plate via connectors, in this example carabiners 75, 77, 79 and 81 which extend through apertures 65, 67, 71 and 73, respectively. The connector plate 63 has a second connection point, in this example in the form of a shackle 87 spaced-apart from the apertures thereof. The second end 58 of the load suspension line 50 couples to the connector plate 63 via a shackle 103 thereof in this example which extends through and couples with shackle 87 of the connector plate.

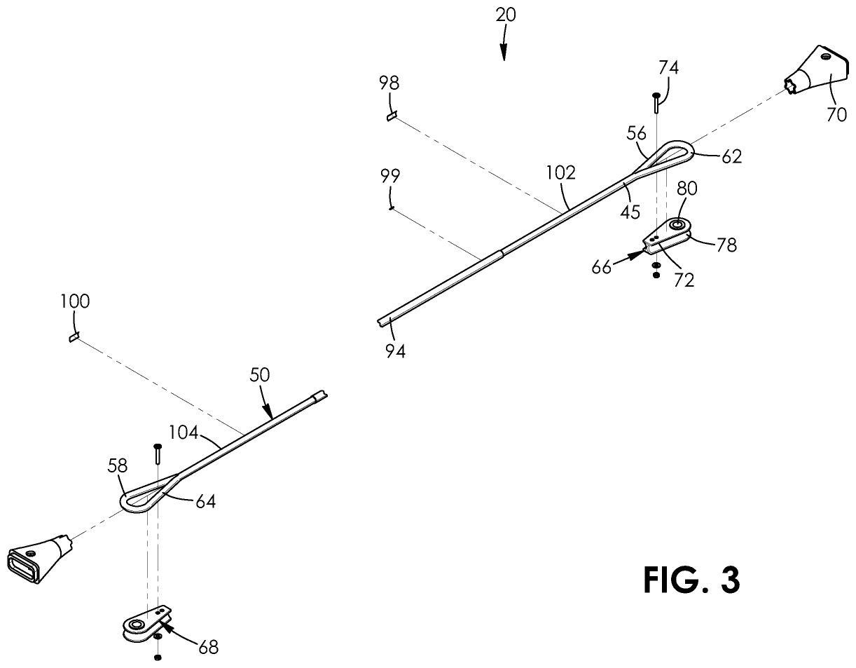

As seen in FIG. 3, the load suspension line 50 includes a pair of spaced-apart attachment points, in this example loop-shaped end portions 62 and 64 formed in this case by eye splicing. The external load transport assembly 20 includes a pair of thimbles 66 and 68 shaped to fit within the loop-shaped end portions of the load suspension line. As seen in FIG. 7, the load suspension line 50 includes a housing for each thimble thereof, in this example in the form of a tapered first housing portion 70 and a second housing portion 76. The first housing portion couples to a proximal portion 72 of the thimble 66 thereof via a fastener 74 and extends about a portion 45 of the load suspension line 50 adjacent to the thimble. The second housing portion 76, which is D-shaped in profile in this example, extends about a distal portion 78 of the thimble. The second housing portion has an aperture 80 which aligns with aperture 82 of the thimble 66. The second housing portion 76 selectively couples to the first housing portion 70, in this example via a female recessed portion or seat 83 of the second housing portion shaped to receive a corresponding male member 85 of the first housing portion. The seat and male member are rectangular in this example; however, this is not strictly required. The housing portions 70 and 76 may be made of urethane rubber in one example; however, this is not strictly required and the housing portions may be made of other materials in other embodiments.

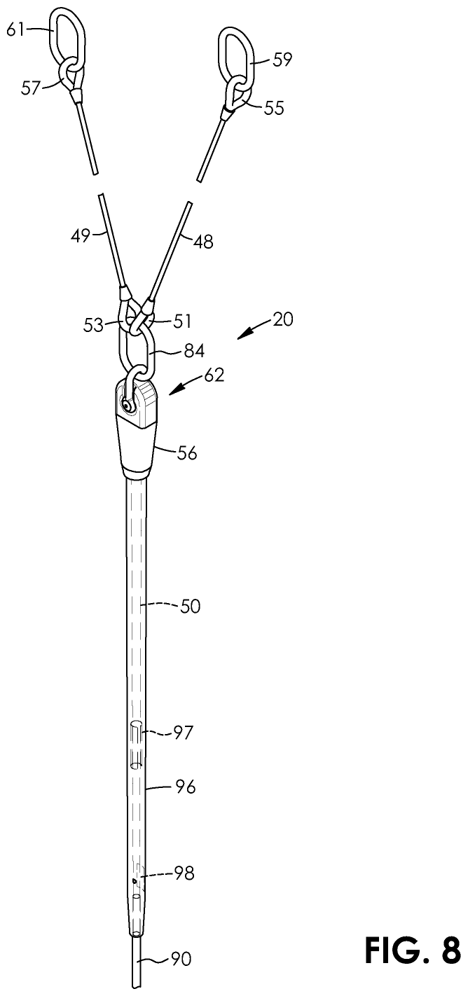

Still referring to FIG. 7, the external load transport assembly 20 includes in this example a first link 84 which is obround in shape in this example. The first link couples to each loop-shaped end portion 62 and thimble 66 via a shackle 86. The shackle has a clevis pin 88 that extends through a first aperture 93 of the shackle, aperture 80 the second housing portion 76, aperture 82 of thimble 66 and a second aperture 95 of the shackle when aligned. The clevis pin may threadably couple to the second aperture of the shackle 86 or be secured via a nut (not shown), for example. A cotter or safety pin 89 extends through an aperture 91 of the clevis pin 88 thereafter and functions to further secures the clevis pin in place. The safety pin 89 may be secured to the clevis pin 88 via a wire lanyard and split ring (not shown). As seen in FIG. 8, first link 84 selectively couples to the Y-lanyard 48.

As seen in FIG. 8, the elongate lanyards 48 and 49 have first connection points, in this example first eyelets 51 and 53 which couple to end portion 62 of the load suspension line 50 via first link 84. The elongate lanyards have second connection points, in this example second eyelets 55 and 57 spaced-apart from the first eyelets thereof. The second eyelets of the elongate lanyards 48 and 49 may selectively couple to the belly 40 of helicopter 22 seen in FIG. 1 via upper links 59 and 61 in this example that extend about and couple to the second eyelets.

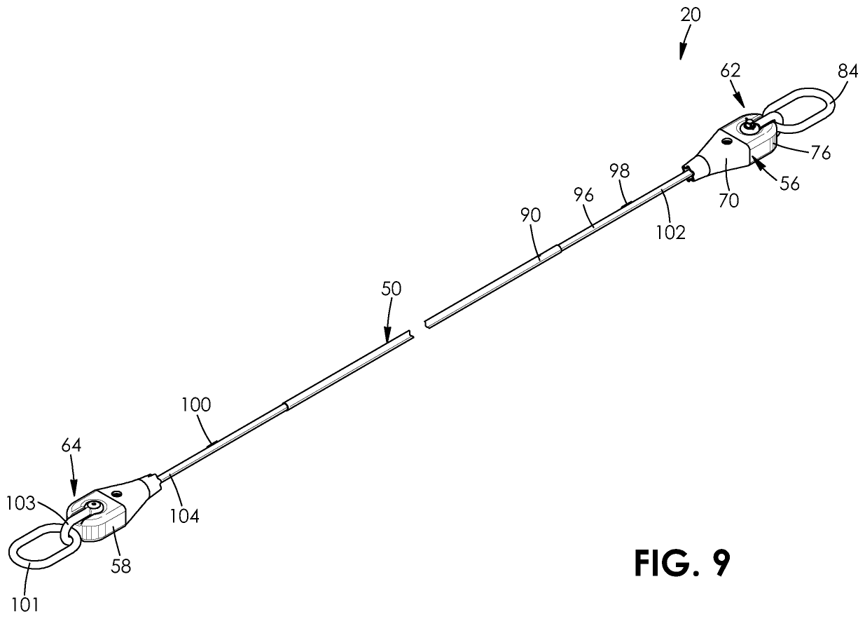

Referring to FIG. 9, the external load transport assembly 20 includes in this example a second link 101 which is obround in shape in this example. The second link couples to loop-shaped end portion 64 via shackle 103 in a like manner as described above for first link 84. The second link 101 selectively couples to harness 60 worn by worker 52 as seen in FIG. 1. The external load transport assembly 20 so configured optionally enables the person to be selectively jettisoned. One or more of the components of the external load transport assembly 20 as herein described may have electrical isolating/insulating properties.

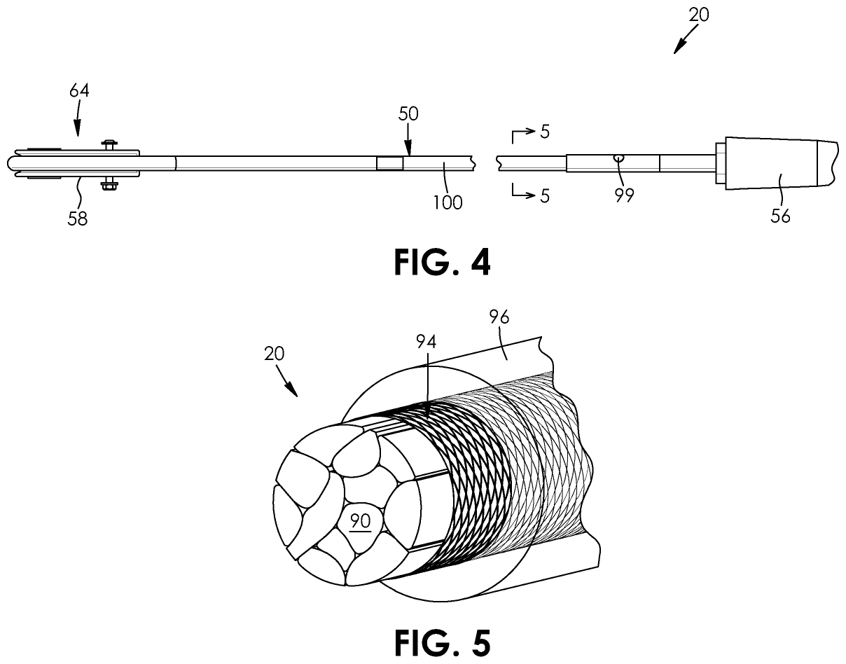

Referring to FIG. 4, the load suspension line 50 includes a structural core comprising a low-stretch rope 90, in this example made of non-metal fibers 92. The rope in this example is a synthetic rope, in this case twelve strand high modulus polyethylene fiber (HMPE) rope. However, this is not strictly required and other non-conducting ropes or lines with electrical isolating/insulating properties may be used in other embodiments. The load suspension line 50 includes a sleeve-shaped woven mesh 94 made of a non-conducting material, in this example a polyester overbraid. The mesh couples to and extends about the synthetic rope 90.

As seen in FIG. 5, the external load transport assembly 20 includes an at least partially transparent coating, in this example a polymer coating, in this instance a polyurethane coating, in this case a fully transparent, clear polyurethane coating 96. However, this is not strictly required and the coating may be translucent in other embodiments and/or made of other materials in other examples. The coating is an off-the-shelf product and in this example comprises Clear Flex™ 30 clear urethane, which may be purchased at Smooth-On, Inc., having an office act 5600 Lower Macungie Road, Macungie, Pa., 18062, USA. However, here too this is not strictly required and other types of coatings may be used in other embodiments. The rope 90 has a nominal diameter of ½ inches and coating 96 has a thickness of 1/16 inches in this example. However here too this is not strictly required and the rope may be of a different size and the coating may be applied to a different thickness in other embodiments.

The clear coating 96 encases the load suspension line 50, in this example encasing the fibers 92 of the rope 90 after eye splicing thereof, in a known humidity environment and so as to seal the fibers from the environment. Alternatively, the clear coating 96 may be considered as part of the load suspension line. The clear polyurethane coating or similar cast or similar process may be used to re-encase the synthetic fibers after splicing. The clear coating 96 encases the fibers of the rope with vacuum degassing to maximize transparency of the coating in this example. The woven mesh 94 seen in FIG. 5 is positioned between the synthetic rope 90 and the clear coating over the entire length of the rope but not adjacent to the splicing portions 102 and 104 thereof.

Referring to FIG. 8, the load suspension line 50 may include one or more labels 97 thereon. The one or more labels are also in this example encased in the clear coating 96 for protection and are viewable through the coating. The one or more labels 97 are identification tags to identify the product and manufacturing record, including the part number, serial number, description, working load limit, life limits of the line, and manufacturing date, for example. The one or more labels 97 are radio-frequency identification (RFID) enabled, though is optional and not strictly required.

As seen in FIG. 3, the load suspension line may include temperature sensors or indicators 99, such as TelaTemp™ stickers, which are off-the-shelf products that may be purchased, for example, at TelaTemp Corporation, 2910-C East La Palma Avenue, Anaheim, Calif. 92806, United States. However, this is not strictly required and other or no temperature indicators may be used in other embodiments if desired. The temperature indicators 99 function to visually warn the operator if the critical load suspension line or rope temperature has been exceeded.

As seen in FIG. 9, the external load transport assembly 20 includes a plurality of more spaced-apart relative humidity sensors or indicators 98 and 100. The relative humidity indicators are off-the-shelf products that may be purchased or adapted from products sold at, for example, one or more of the following entities: Static Control Industries™, having an address of 926 JR Industrial Drive, Sanford, N.C. 27332, USA; or Clariant SE, Ostenrieder Str. 15, 85368 Moosburg, Germany. However, this is not strictly required and relative humidity indicators of a different type may be used and/or purchased elsewhere in other embodiments.

Still referring to FIG. 9, each of the relative humidity indicators 98 and 100 couples to and is spaced-apart along the load suspension line 50. Each relative humidity indicator is positioned to monitor moisture content of the load suspension line, in this case monitoring the fibers 92 of the load suspension line seen in FIG. 5. Each relative humidity indicator 98 seen in FIG. 8 is configured to provide a visual indication of changes in dielectric properties of the load suspension line 50.

The clear coating 96 seen in FIG. 5 encases the relative humidity indicators 98 seen in FIG. 8 adjacent to the fibers of the rope to reflect properties over the length of the load suspension line. The humidity indicators and temperature-indicators 99 may be first taped or adhered in place, with the clear coating encasing the indicators thereafter. Referring to FIG. 8, the relative humidity indicators 98 and 100 are protected by and viewable through the clear coating 96. The relative humidity indicators are in fluid communication with the synthetic rope and are viewable via the clear coating. The relative humidity indicators 98 and 100 may comprise color changing strips. The relative humidity indicators may be located in the end splice, in the last three feet of the line and near the top of the urethane, for example.

If the load suspension line 50 absorbs moisture, it may no longer be dielectric and thus could conduct electricity. The load suspension line as herein described may thus be referred to as a dielectric line comprising both clear urethane coated cable and moisture indicators in the line, for use in carrying human external cargo when flying in a power line environment for inspection applications and the like.

The clear coating 96 seen in FIG. 5 allows the operator/worker to see what is inside the line 50. With everything covered in clear urethane, splicing portions 102 and 104 of the rope 90 seen in FIG. 9 arising from the eye splicing remain visible for inspection at all times. This enables operators to perform daily visual checks and pre-emptively know when slices may be loosening, with the latter suggesting that the integrity of the line 50 may be jeopardized.

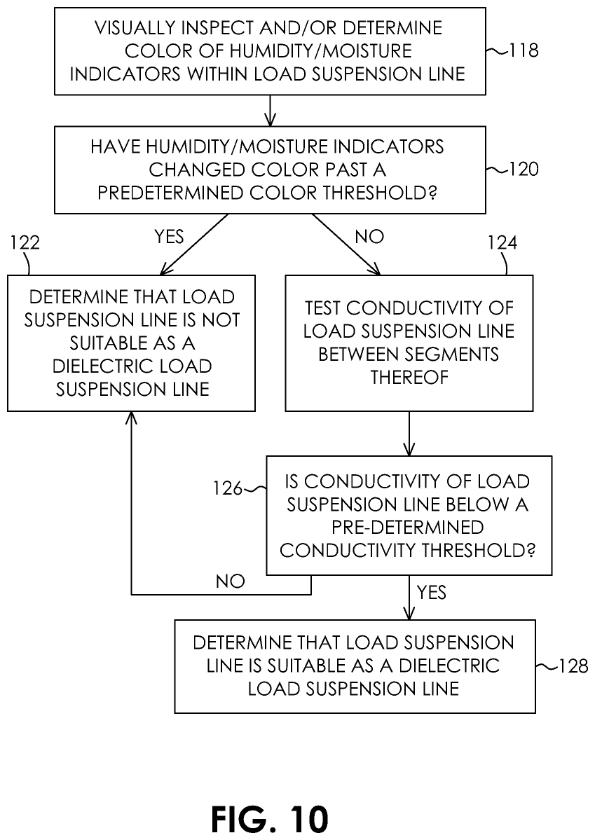

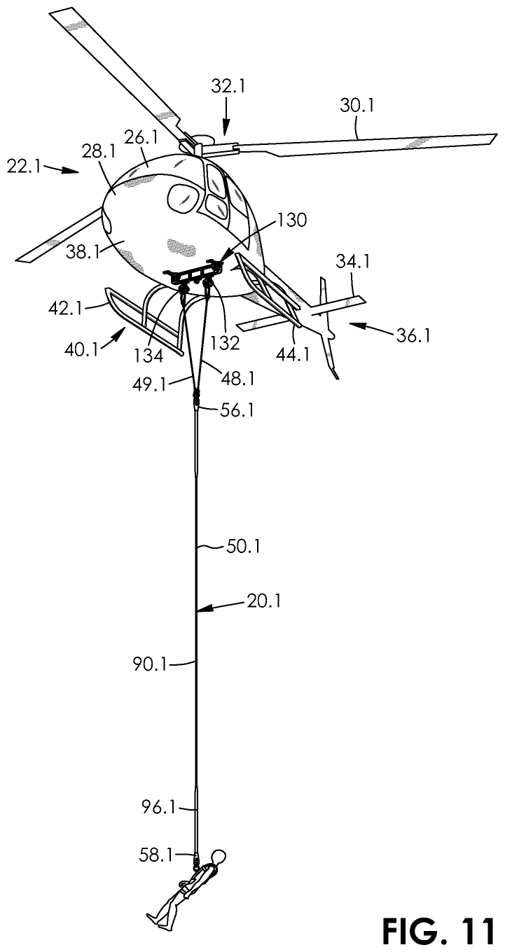

A method/algorithm for determining whether the load suspension line in a dielectric state is shown in FIG. 10. In this embodiment, the operator visually inspects and/or determines the color of the humidity/moisture indicators of the load suspension line, as shown by box 118. The operator next determines whether the humidity/moisture indicators have changed color past a predetermined color threshold, as shown by box 120. If yes, it is determined that the load suspension line is not suitable for use as dielectric load suspension line. This is shown by box 122. No further testing is performed, another load suspension line undergoes this method/algorithm, and this method/algorithm may thus comprise a timely means of determining whether a load suspension line is suitable for use as a dielectric line with a default safety factor of assuming that the line is not suitable where the humidity/moisture indicators have exceeded a change of color threshold.

If the humidity/moisture indicator is below the color threshold, then according to the algorithm/method set out in FIG. 10, a test of the conductivity of the load suspension line between spaced-apart segments thereof is next performed, as shown by box 124. The method includes determining whether the conductivity test result or conductivity of the load suspension line is below a pre-determined conductivity threshold as shown by box 126. If the test result or conductivity of the load suspension line is above the pre-determined conductivity threshold, it is determined that the load suspension line is not suitable for use as dielectric load suspension line. This is shown by box 122.

If the conductivity test result or conductivity of the load suspension line is below the pre-determined conductivity threshold, in this case it is only then determined that the load suspension line is suitable for use as dielectric load suspension line as shown by box 128. This method/algorithm thus determines that the load suspension line is a dielectric state when both i) the color of the one or more relative humidity indicators is determined to have not changed one or more predetermined color thresholds; and ii) conductivity of the load suspension line has not exceeded a predetermined conductivity threshold. The method/algorithm set out in FIG. 10 may thus provide extra layers of safety in promoting use of the load suspension line 50 only when in a non-conducting and dielectric state.

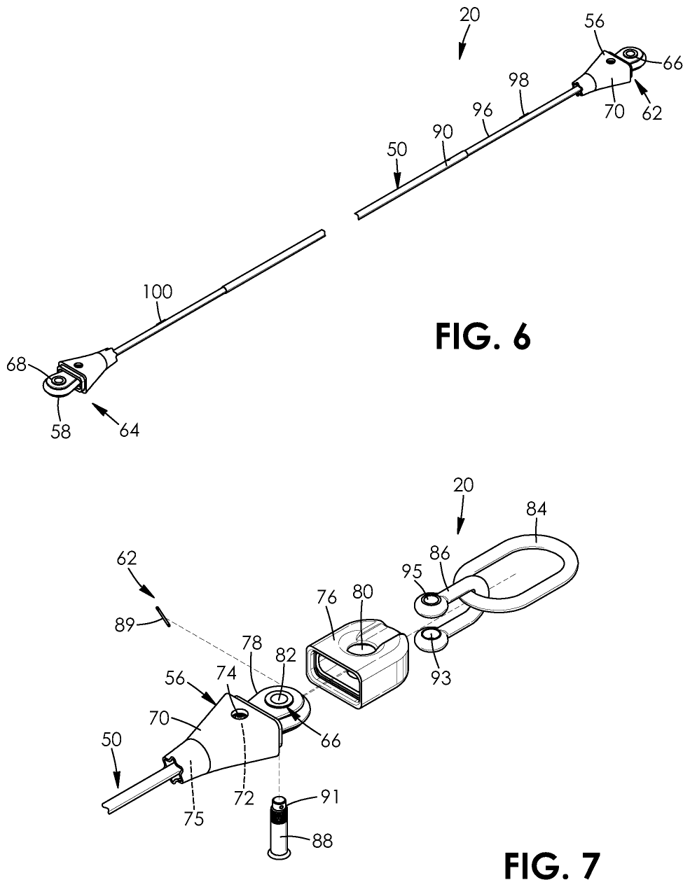

FIG. 11 shows an external load transport assembly 20.1 according to a second aspect for an aerial vehicle, in this example helicopter 22.1. Like parts have like numbers and functions as the external load transport assembly 20 shown in FIGS. 1 to 10 with the addition of decimal extension “0.1”. External load transport assembly 20.1 is substantially the same as the external load transport assembly 20 shown in FIGS. 1 to 10 with at least the following exceptions.

In this embodiment, the helicopter 22.1 includes a belly-mounted load beam 130 with a pair of spaced-apart hooks 132 and 134 coupled thereto. This is described in more detail in U.S. Pat. No. 10,745,131 filed on 26 Oct. 2017, the disclosure of which is hereby incorporated herein by reference. Lanyards 48.1 and 49.1 couple to the belly-mounted load beam via the hooks.

As a further alternative, the helicopter may include one or more belly mounted cargo hooks coupled to the belly of the helicopter and to which the lanyards couple.

### ADDITIONAL DESCRIPTION

Examples of external load transport assemblies have been described. The following clauses are offered as further description.
(1) An external load transport assembly for an aerial vehicle, the assembly comprising: a load suspension line having a first end connectable to the aerial vehicle and a second end connectable to an external load; a relative humidity indicator positioned to monitor moisture content of the load suspension line; and an at least partially transparent coating encasing the load suspension line and the relative humidity indicator.
(2) A transport assembly for an aerial vehicle, the assembly comprising: a load suspension line extending between and selectively coupling an external load to an undercarriage of the aerial vehicle; a relative humidity indicator coupled to the load suspension line; and an at least partially transparent coating encasing the load suspension line and the relative humidity indicator.
(3) The assembly of any one of clauses 1 to 2, wherein the relative humidity indicator is configured to provide a visual indication of changes in dielectric properties of the load suspension line.
(4) The assembly of any one of clauses 1 to 3, wherein the coating is a polymer said coating.
(5) The assembly of any one of clauses 1 to 3, wherein the coating is a polyurethane said coating.
(6) The assembly of clause 5, wherein the coating is a clear polyurethane said coating.
(7) The assembly of any one of clauses 1 to 6 wherein parts thereof have electrical isolating/insulating properties.
(8) The assembly of any one of clauses 1 to 7 wherein the relative humidity indicator is protected by and viewable through the at least partially transparent coating.
(9) The assembly of any one of clauses 1 to 8, wherein the load suspension line comprises a rope made of non-metal fibers and wherein the relative humidity indicator monitors the fibers.
(10) The assembly of any one of clauses 1 to 8, wherein the load suspension line comprises a rope made of non-metal fibers and wherein the at least partially transparent polymer encases the relative humidity indicator adjacent to the fibers to reflect properties over a length of the load suspension line.
(11) The assembly of any one of clauses 1 to 8, wherein the load suspension line comprises synthetic rope.
(12) The assembly of any one of clauses 1 to 8, wherein the load suspension line comprises high modulus polyethylene fiber (HMPE) rope.
(13) The assembly of any one of clauses 9 to 12 wherein the at least partially transparent coating encases the fibers of the rope after splicing thereof in a known humidity environment and so as to seal the fibers from the environment.
(14) The assembly of any one of clauses 9 to 12 wherein the at least partially transparent coating encases the fibers of the rope with vacuum degassing to maximize transparency of the coating.
(15) The assembly of any one of clauses 1 to 8 wherein the load suspension line comprises a structural core comprising synthetic rope, and a clear polyurethane the coating, with the relative humidity indicator being in fluid communication with the synthetic rope and being viewable via the clear polyurethane said coating.
(16) The assembly of clause 15 wherein the load suspension line further includes a non-conducting woven mesh extending about the synthetic rope and being positioned between the synthetic rope and the clear polyurethane said coating.
(17) The assembly of any one of clauses 1 to 16 further including a second said relative humidity indicator, the relative humidity indicators being spaced-apart from each other along the load suspension line.
(18) The assembly of any preceding clause, wherein the relative humidity indicator is positioned adjacent to a splicing region of the load suspension line.
(19) The assembly of any preceding clause, further including one or more temperature indicators coupled to the rope and encased by the clear coating.
(20) The assembly of any preceding clause wherein the external load is a human.
(21) Use of the assembly of any one of clauses 1 to 20 for construction or maintenance of power lines.
(22) In combination, an aerial vehicle and the assembly of any one of clauses 1 to 20.
(23) A load suspension line having a first end connectable to an aerial vehicle, having a second end connectable to an external load, including synthetic rope, including a relative humidity indicator positioned to monitor moisture content of the synthetic rope, and including an at least partially transparent coating encasing the synthetic rope and the relative humidity indicator.
(24) A load suspension line for coupling an external load to an aerial vehicle, the load suspension line being made of non-conducting material, including a relative humidity indicator positioned to monitor moisture content thereof, and including an at least partially transparent coating encasing the relative humidity indicator.
(25) A method of determining whether a load suspension line of an external load transport assembly for an aerial vehicle is in a dielectric state, the load suspension line being made of non-conducting material and the method comprising: coupling one or more relative humidity indicators to the synthetic rope; encasing the one or more relative humidity indicators and portions of the rope adjacent thereto in an at least partially transparent coating; testing conductivity of the load suspension line over a certain segment thereof; visually inspecting the one or more relative humidity indicators; and determining that the load suspension line is a dielectric state when both i) the color of the one or more relative humidity indicators is determined to have not changed one or more predetermined color thresholds; and ii) conductivity of the load suspension line over the certain segment has not exceeded a predetermined conductivity threshold.

It will be appreciated that many variations are possible within the scope of the invention described herein. The external load transport assembly 20 has been described herein for use as a helicopter insertion and extraction tool for construction and maintaining power lines where the worker is suspended from the helicopter. In addition or alternatively, the external load transport assembly as herein described may be used for forest fire fighting, law enforcement, and search and rescue operations, for example.

The external load transport assembly 20 as herein described is modular and various other components may be coupled thereto such as, for example, a rescue basket or an aerial rescue platform. The external load transport assembly may thus be used as part of a helicopter flight rescue system or helicopter external transport system.

The load suspension line 50 as herein described may be referred to a longline or shortline.

The clear coating 96 may encase only the splicing portions of the rope 90 or, alternatively, may encase the whole of the rope.

It will also be understood by someone skilled in the art that many of the details provided above are by way of example only and are not intended to limit the scope of the invention which is to be determined with reference to at least the following claims.

What is claimed is:

1. An external load transport assembly for an aerial vehicle, the assembly comprising:
a load suspension line having a first end connectable to the aerial vehicle and a second end connectable to an external load;
a water-content or relative humidity indicator positioned to monitor moisture content of the load suspension line; and
an at least partially transparent coating encasing the load suspension line and the indicator.

2. The assembly of claim 1 wherein the indicator is protected by and viewable through the at least partially transparent coating.

3. The assembly of claim 1 wherein the indicator is configured to provide a visual indication of changes in dielectric properties of the load suspension line.

4. The assembly of claim 1 wherein the coating is at least one of: a clear said coating; a polymer said coating; a polyurethane said coating; and a clear polyurethane said coating.

5. The assembly of claim 1 wherein the load suspension line comprises at least one of: a structural core made of a non-conducting material; synthetic rope; rope made of non-metal fibers; and high modulus polyethylene fiber (HMPE) rope.

6. The assembly of claim 1 wherein the load suspension line comprises a rope made of non-metal fibers and wherein the at least partially transparent coating encases the indicator adjacent to the fibers to provide a visual signal of moisture properties thereof over a length of the load suspension line.

7. The assembly of claim 1 wherein the load suspension line includes rope made of fibers, and wherein the at least partially transparent coating encases the fibers of the rope after splicing of the fibers in a known humidity environment so as to seal the fibers from the environment.

8. The assembly of claim 1 wherein the load suspension line includes rope made of fibers, and wherein the at least partially transparent coating encases the fibers of the rope with vacuum degassing to maximize transparency of the at least partially transparent coating.

9. The assembly of claim 1 wherein the load suspension line includes a synthetic rope and wherein the load suspension line includes a non-conducting woven mesh extending about the synthetic rope, the non-conducting woven mesh being positioned between the synthetic rope and the at least partially transparent coating.

10. The assembly of claim 1 further including a second said water-content or relative humidity indicator, the indicators being spaced-apart from each other along the load suspension line.

11. The assembly of claim 1 further including one or more temperature indicators coupled to the load suspension line and encased by the at least partially transparent coating, the temperature indicators providing a visual signal of whether the load suspension line has been subjected to a threshold critical temperature.

12. The assembly as claimed in claim 1, wherein the load suspension line includes a first attachment point connectable to the aerial vehicle, a second attachment point connectable to an external load, the attachment points formed via splicing, and splicing portions adjacent to said attachment points, and wherein the at least partially transparent coating encases at least said splicing portions of the load suspension line.

13. Use of the assembly of claim 1 for construction or maintenance of power lines.

14. In combination, an aerial vehicle and the assembly as claimed in claim 1.

15. A load suspension line for coupling an external load to an aerial vehicle, the load suspension line being made of non-conducting material, including a relative humidity indicator positioned to monitor moisture content thereof, and including an at least partially transparent coating encasing the relative humidity indicator.

16. A method of determining whether a load suspension line of an external load transport assembly for an aerial vehicle is suitable for use as a dielectric said load suspension line, the load suspension line being made of non-conducting material, and the method comprising:
a) coupling one or more water-content or relative humidity indicators to the load suspension line;
b) encasing the one or more indicators and portions of the load suspension line adjacent thereto in an at least partially transparent coating; and
c) determining whether the one or more indicators have changed color past a predetermined color threshold and using this information to determine whether further testing of the load suspension line should be performed.

17. The method as claimed in claim 16, wherein if the one or more indicators have changed color past the predetermined color threshold, the method further including:
d) testing conductivity of the load suspension line between segments thereof and
i) if the test result is below a pre-determined conductivity threshold, determining that the load suspension line is suitable for use as the dielectric said load suspension line, and
ii) if the conductivity of the load suspension line exceeds the pre-determined conductivity threshold, determining that the load suspension line is not suitable for use as the dielectric said load suspension line.

18. The method as claimed in claim 16, wherein if the one or more indicators have not changed color past the predetermined color threshold and the load suspension line has previously been determined to be suitable for use as the dielectric said load suspension line, the method further including:
d) determining that the load suspension line continues to be suitable for use as the dielectric said load suspension line.

19. The method as claimed in claim 16, wherein if the one or more indicators have not changed color past the predetermined color threshold, the method further including:
d) testing conductivity of the load suspension line between segments thereof and
e) determining that the load suspension line is suitable as the dielectric said load suspension line if both
i) the one or more indicators have not exceeded the predetermined color threshold and
ii) the conductivity of the load suspension line is below a pre-determined conductivity threshold.

20. The method as claimed in claim 16, the method further including within step c:
coupling one or more temperatures indicators to the load suspension line, and
determining whether the one or more temperature indicators have changed color past a predetermined color threshold and if yes, determining that the load suspension line is not suitable for use as the dielectric said load suspension line.
